(19) United States
(12) Patent Application Publication
(10) Pub. No.: US 2002/0020740 A1
(43) Pub. Date: Feb. 21, 2002

(54) Financial transaction card

(76) Inventor: Michael Thomas Aarons, Fountain Valley, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/836,729

(22) Filed: Apr. 17, 2001

Related U.S. Application Data
(60) Provisional application No. 60/197,571, filed on Apr. 17, 2000.

(51) Int. Cl. G06K 5/00

(52) U.S. Cl. 235/380

(57) ABSTRACT

A secured method of storing personal credit card information that may be used for Internet purchasing or debit exchanges on the Internet or networked computers and also for over-the-counter purchases for businesses that have computer equipment but lack credit card readers or credit card imprint machines. Credit card information is stored on a modified form of optical disc in an encrypted manner to prevent reading of the information by unauthorized persons. Validation software either at the Internet vendor's site or local to the user's computer is used to decode the credit card information in a secure manner. Methods are also provided for traditional storage of credit/debit card data on magnetic a stripe.

This application claims the benefit of priority under 35 U.S.C. § 119(e) from U.S. Provisional Application No. 60/197,571 filed on Apr. 17, 2000.

### BACKGROUND OF THE INVENTION

1. Field of the Invention

This invention relates to the use of magnetic strip plastic credit cards used for the storage of personal account information. More particularly, this invention stores standard credit card information in multiple forms onto an optical disc for use in standard personal computers.

Current credit/debit cards lack the ability to be read on standard computer equipment. Thus, when used for Internet purchases, the user is forced to manually enter the account number as printed on the card. This provides a breach in security and also leaves the transaction exposed to possible entry errors or fraudulent entries.

The advantage of a credit format with Compact Disc or Digital Video formatting is that such an instrument is readable on most standard equipped personal computers.

2. Description of the Related Art

There have hitherto been actual inventions that have been in use worldwide for storing account and personal information on a rectangular plastic card containing an embedded magnetic stripe that contains the actual data encoded in a format suitable for reading in the magnetic domain. The dimensions of this plastic card are typically 5.4 cm by 8.6 cm. The format is accepted worldwide as a standard for financially related credit and debit cards.

The card typically contains information on the front pertaining to the card owner. Typical information is the card users name, card or account number and valid dates of use for the card.

The reverse side of the card contains a magnetic stripe that incorporates one to three channels of encoded information for use in reading the card magnetically.

FIG. 1 shows prior art defining existing plastic credit cards. The base material of the card is shown as item 101. The magnetic stripe is depicted by item 102. The information contained on the magnetic stripe is read by physically sliding the magnetic stripe across a magnetic recording head. The magnetic impulses permanently stored on the magnetic stripe 102 are converted into electrical pulses and decoded after amplification and shaping. The plastic card 101 is moved across the magnetic head either from the card user's muscular power or is motor driven by some mechanical method.

FIG. 2 shows prior art of what is classically termed an “8 centimeter Compact Disc.” This device is used to store information in an optical format that is read through the use of lens systems and laser devices. The data is physically recorded on the media as either a series of light and dark spots or as a series of pits and lands. Optical disc 201 is rotated physically around the hub 203. Data 202 is recorded spirally from the inside nearest the hub to the outside edge of 201. The disc 201 can contain any amount of information from no information to maximum allowed for that format of disc. The recorded data is typically not redundant but employs error correction methodology to recover data that might be lost due to surface defects. Data is recorded contiguously and generally does not contain areas where no data exists. The general shape of 201 is defined to be round by industry specifications.

FIG. 3 depicts prior art that improves on the 8 centimeter Compact Disc. The substrate 301 can start as essentially circular but has two sides removed to reduce the overall width of the disc. The purpose of removing two sides is to allow the “disc” to be stored in the user's pocket book in a manner similar to plastic credit cards defined in FIG. 1. The overall length of the card is shorter than standard credit cards but the width allows 301 to fit into pocket books and card reading devices.

FIG. 4 depicts the preferred embodiment of this invention and improves on prior art of FIG. 3 by adding a magnetic stripe to allow the invention to be used as a standard credit/debit card. The substrate 401 has two sides defined as SIDE 1 and SIDE 2. Side 1 contains data 403 stored optically encoded on the substrate 401. Side 2 contains a magnetic stripe 402 that contains data that is magnetically encoded. The magnetically encoded data is read by sliding the stripe across a magnetic reader head. The optically encoded data is read by rotating the invention around a center hub and reflecting laser light off the data for detection.

FIG. 5 shows the mounting tray 501 of a standard CD-ROM and DVD computer peripheral. The tray is extended from the drive when the disc must be loaded or unloaded. Concentric depressions 502 and 503 in the tray allow the user to center the disc prior to allowing the tray to retract. Depression 502 serves to center the standard 8-centimeter disc while depression 503 is used to center standard 12-centimeter discs. The center part 504 of the tray has all tray material removed to allow the drive hub mechanism to engage the disc when it is loaded into the peripheral.

FIG. 6 depicts one form of a standard credit/debit card reader. The device is designed to read the magnetic stripes of standard credit/debit cards. The body of the device 601 contains an embedded magnetic head 602 and a formed slot 603. The magnetic head 602 resides in the center part of the enclosure. The slot 603 extends through the length of the device and is used to maintain the depth of insertion for the card. Slot 603 also serves to maintain contact with the magnetic stripe 605 of the credit/debit card 604. The device is used by manually sliding the credit/debit card 604 along the slot 603 from the beginning of the credit/debit card to the end of the card.

FIG. 7 shows an exploded view of the data packets 702a through 702k recorded on the optical portion of the card 701. Each data packet contains one or more account numbers encoded in optical format and encrypted such that the account number is not readable by an average user. Each packet contains redundant information such that if one packet cannot be read, another packet is available. The packets are recorded in a spiral fashion starting closest to the center and spiraling out towards edge.

FIG. 8 depicts data packets 802 that can no longer be read due to surface defects 804 in the form of scratches. In normal use as a credit/debit instrument, the user will insert the card in magnetic reader devices to the read magnetic stripe 803. Due to friction and non-smooth surfaces in the magnetic reader, the surface of the card 801 will accumulate surface defects 804a that cause the data packets to be unreadable in the optical domain. Due to inappropriate use of the card (insertion into the magnetic reader incorrectly by the user, surface defects 804b opposite of the side containing the magnetic stripe 803 will also prevent the reading of data packets. Redundant packets 802a through 802d maintain the ability to read the data in the optical domain.

FIG. 9 displays the flow diagram for using an agent or portion of software to validate the credentials of the credit instrument. The agent may be loaded either from the credit/debit card or from the transaction processor via a networked connection. The agent's sole purpose is to verify the user's Personal Identification Number (PIN) locally to prevent the need for the PIN to be transferred over a networked environment.

### SUMMARY OF THE INVENTION

It is therefore an object of the present invention to provide a method of storing encoded account information in a format that is readable on most current personal computers. This is accomplished by encoding the account information in a format compatible with standard forms of optical disc drives such that the credit/debit instrument may be inserted into a user's computer or the computer of a business organization for direct reading of the account information by the computer.

It is also an object of the present invention to provide redundancy in the information to ensure data readability in the optical realm in spite of numerous surface defects imposed by the day-to-day usage of the invention.

It is also an object of the present invention to optionally provide a method of recording data that is subject to periodic change. Credit/debit instruments are oftentimes associated with additional security codes that must be entered by the instrument's owner. These security codes are routinely termed Personal Identification Numbers or PIN numbers. The invention provides this ability by providing a certain type of media that is either writable or re-writable allowing additional recording of information after the original information or the recording of new information by writing over the old information.

It is also an object of the present invention to optionally encrypt the data containing one or more account numbers for the purpose of preventing a person of normal intelligence from reading the account numbers directly from the device.

It is also an object of the present invention to provide a mechanism that permits the use of an agent, in the form of computer software, that may be downloaded into the user's computer on a permanent or temporary basis for the purpose of ensuring that the invention is physically residing on the user's computer.

It is also an object of the present invention to optionally provide a form of reverse compatibility that allows the invention to provide credit/debit account information in a format compatible with existing credit/debit card reading devices. This is accomplished by providing a method of mounting a magnetic stripe on the invention and taking necessary precautions to prevent the use of the magnetic stripe from eroding the data optically encoded on the invention.

It is also an object of this invention to provide a means for storing multiple credit card numbers for the user. The user is then provided a choice by the associated software agent, at the moment of transaction, which of the credit card numbers will be used for the transaction.

It is also an object of this invention to provide a means of storing shipping addresses (locations were purchased merchandise may be delivered to) on the device to allow the user to pick one of the multiple addresses at the time of transaction. The reason for the multiple shipping addresses is to eliminate fraudulent use of the account by users that ship the merchandise to untraceable addresses. Prior to the creation of the device, the shipping addresses are verified.

### BRIEF DESCRIPTION OF THE DRAWINGS

FIG. 1 is a plain view of a standard credit/debit card. It displays the relative dimensions of card and the relative size and positioning of the magnetic stripe.

FIG. 2 is an isometric view of an 8-centimeter diameter compact disc. It is also representative of any additional optical disc such as digital video.

FIG. 3 is an isometric view of prior art displaying how the form factor of a standard 8-centimeter optical disc is modified to simulate a standard credit/debit card.

FIG. 4 is an isometric view of both sides of FIG. 3 showing the improvement over existing art with the addition of a magnetic stripe.

FIG. 5 is an isometric view of the loading tray of a standard optical disc drive when used as a computer peripheral device.

FIG. 6 is an isometric view of a conventional credit/debit card reader having the intended purpose of reading the magnetic stripe located on the surface of the credit/debit card.

FIG. 7 is a plain view of proposed redundant data packets recorded on the optical portion of the invention.

FIG. 8 is a plain view of the invention containing surface defects in the form of scratches.

FIG. 9 is a flow diagram of an agent or piece of software used to validate the user's Personal Identification Number.

### DETAILED DESCRIPTION OF THE PREFERRED EMBODIMENTS

Referring to the drawings, in particular FIG. 7 the preferred illustrative embodiments of the present invention will be explained in detail.

Data packets 702a through 702k may reside on any standard form of Compact Disc or Digital Versatile Disc. In the preferred embodiment, the data packets optionally reside on a specially designed disc intended to simulate a credit card. The data packets may also be included on a standard circular disc and may or may not be accompanied with software designed to use the credit information contained within the packets.

Each packet is designed to be read individually on a standard CD or DVD drive computer peripheral. If only one data packet is actually readable then all information contained on the invention is usable.

The packets are made to be redundant and are evenly distributed across the surface of the substrate 701 to provide a safety factor to ensure that at least one packet may be recovered.

The packets are recorded in a spiral pattern as dictated by the rules of encoding for the intended computer peripheral device. The redundant packets may or may not completely fill the usable data area of the media.

The data packets are read from the media by inserting the invention into the appropriate computer peripheral device tray. FIG. 5 shows an approximate design for a standard CD or DVD drive tray.

The invention is placed into the drive manually by the computer user. When the invention is shaped similar to the embodiment shown in FIG. 3, it is centered and contained in the drive tray 501 by the depression 502.

After placing the invention in drive tray 501, the tray is withdrawn into the drive and the invention is rotated about its hub 305.

While rotating, the media passes under an optical read head of the drive that incorporates a laser device to be reflected off the surface of the invention and convert the data, recorded as a series of dark and light spots or as pits and lands to digital characters usable by the computer system.

If the invention contains optical additional software that is required to run in order to provide directions to the user or to act as an agent to decrypt the account information contained on the invention, it is loaded into the computer first. The data may or may not be redundant.

If the user is currently performing a transaction over a network or Internet that requires software or an agent to read the account data, that software my optionally be attained over the network or Internet instead of from the invention itself.

If an additional level of security is desired to ensure the invention is physically inserted into the user's computer, the downloaded software or agent can check the physical location of the invention and report that information to the transaction processor if required.

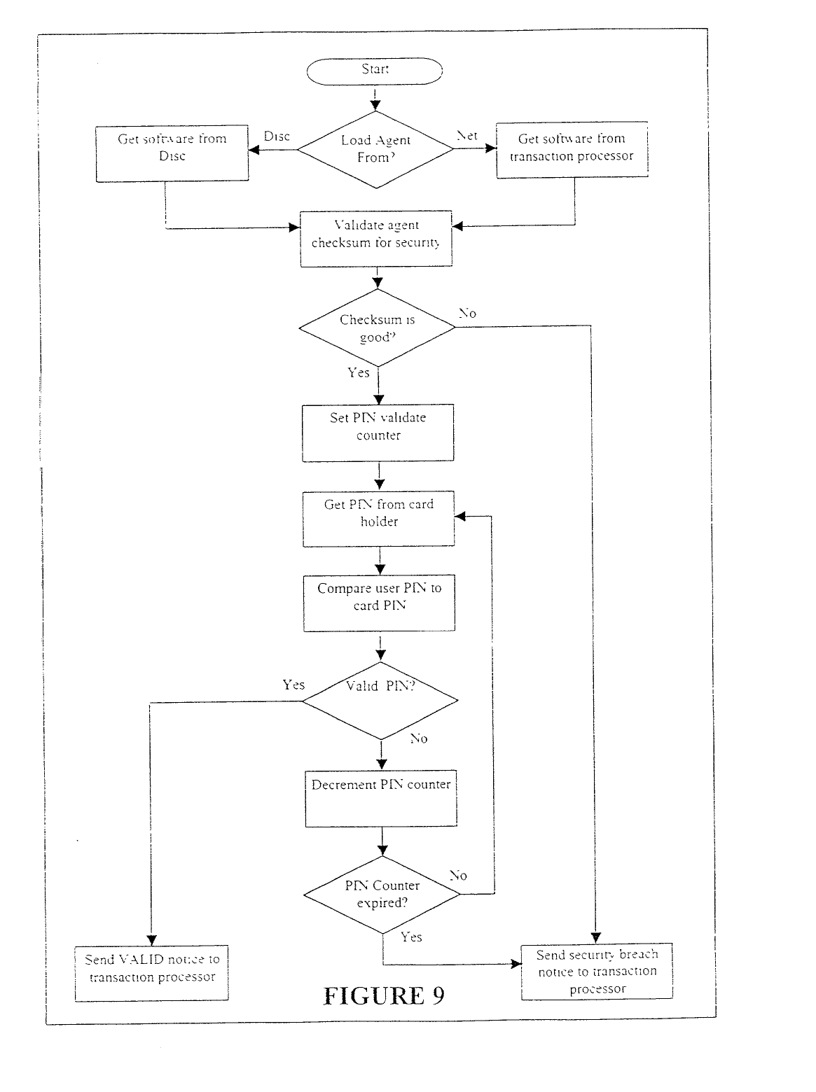

An even higher level of security, as shown in FIG. 9, can be employed to ensure that only the true owner of the invention is indeed using it for the transaction. This is performed by the use of a Personal Identification Number or PIN. The PIN is normally not recorded as a part of any transaction and is usually memorized by the user of the credit instrument and manually entered as part of a transaction. The PIN will usually physically reside on the credit instrument.

In a network or Internet environment it is desirable that the PIN number not be transferred over the network to prevent its interception for fraudulent uses. In this situation, the software or agent that was downloaded to permit the reading of the encrypted account information is also used to verify the PIN. The software or agent will then notify the transaction processor at the receiving end of the network that the PIN was or was not correct. At no time is the content of the PIN ever transferred over the network.

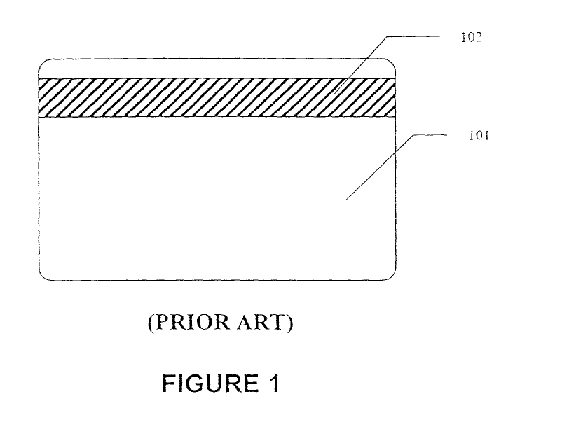

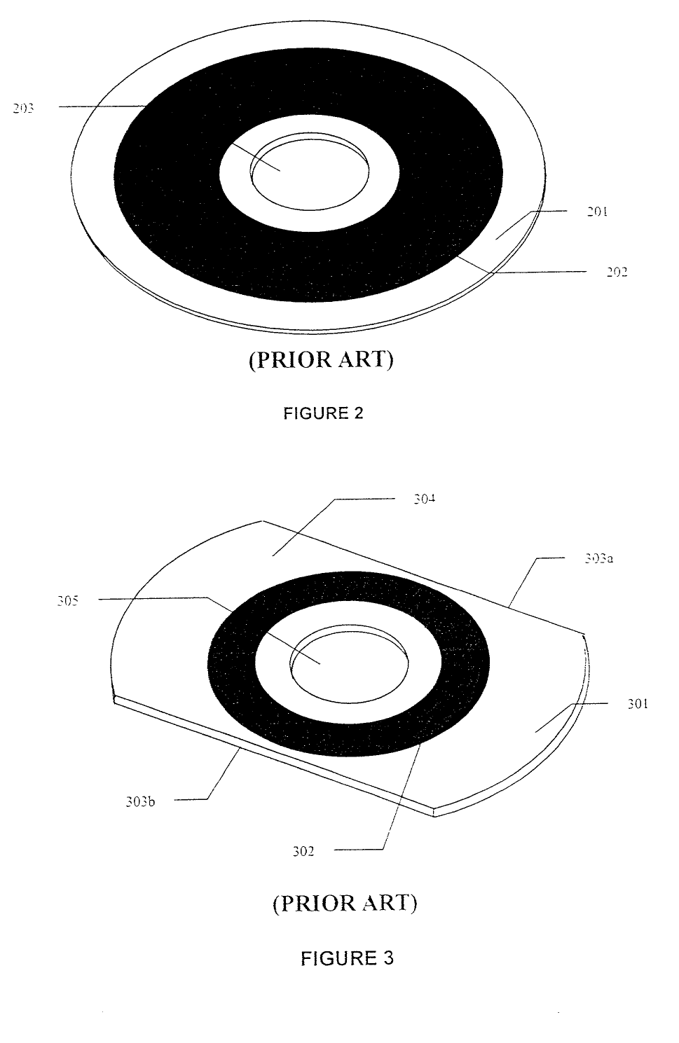

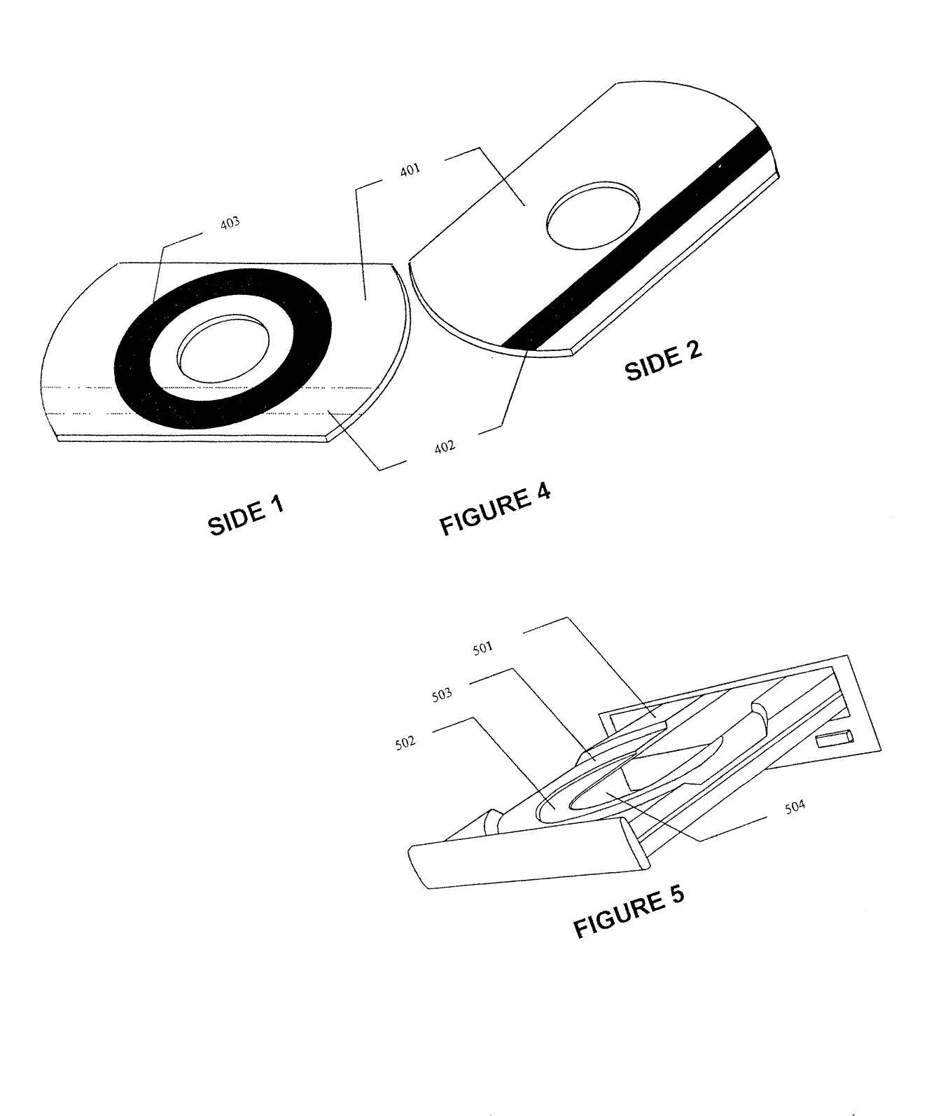

The credit instrument can also be made to simulate a standard credit card as shown in FIG. 1. When used as a standard credit card the invention must include a magnetic stripe as depicted in FIG. 4. The magnetic stripe 402 is placed on the side opposite the optically encoded data 403. When the magnetic stripe is included on the invention, the account data is stored on the stripe in magnetic encoding.

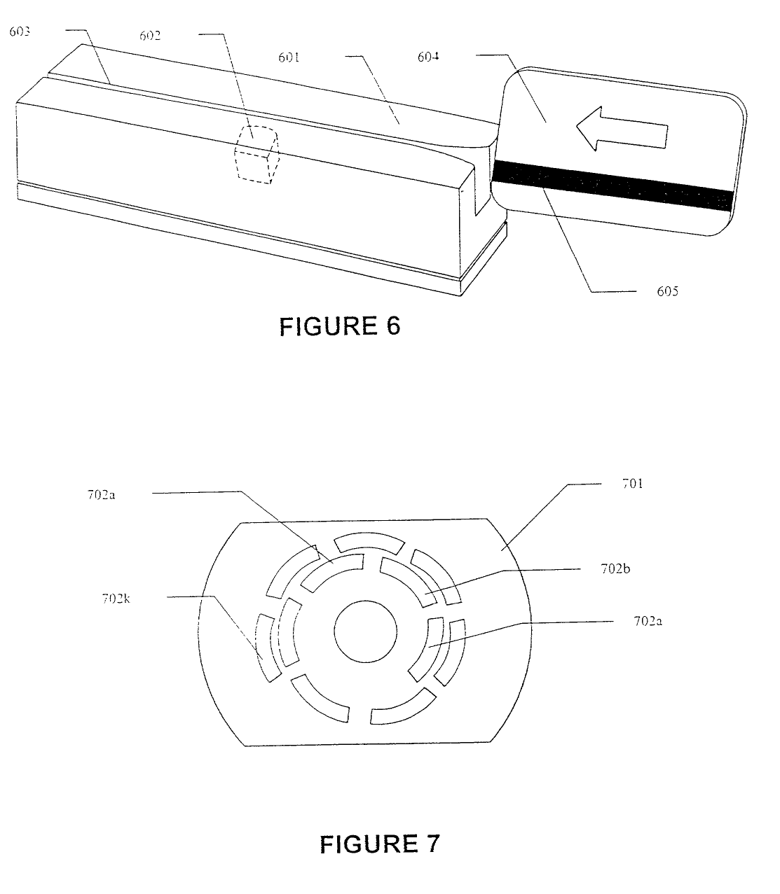

To use the magnetically encoded information, the user will pass the invention through a magnetic card reader as depicted in FIG. 6. the card reader 601 contains a slot 603 that physically guides the card 604 against the magnetic head 602 allowing the data on the magnetic stripe 605 to be read. The card can also be mechanically inserted using a mechanism to pass the card across a magnetic head eliminating the need for the user to physically move the card.

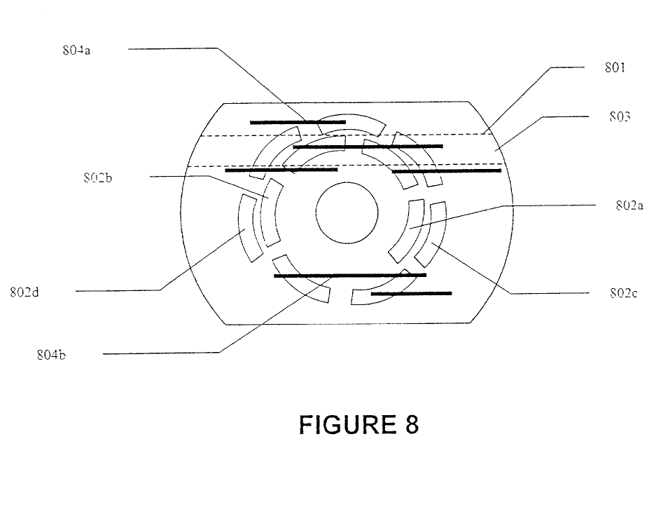

In the process of using the magnetic stripe as a form of credit the invention will sustain physical damage to the surface in the form of surface scratches. This is depicted in FIG. 8. The scratches 804a are usually sustained on the edge of the card containing the magnetic stripe. The scratches are usually sustained on both sides of the invention and will cause a problem in recovering the account information shown as 802. Occasionally, due to user error, the card may be inserted into a reader in the wrong manner causing scratches 804b to be sustained on the end of the invention opposite the magnetic stripe. These scratches will also prevent recovery of the account information.

Since the scratches 804a and 804b are contained to each end of the invention, account information 802a through 802d remains readable in the optical domain. Since all account information is maintained in a redundant manner the data 802a through 802d are identical and only one packet need be recovered to provide account information.

What is claimed is:

1. The use of an optical disc, commonly referred to as “Compact Disc” or Digital Versatile Disc” that contains an embedded and encrypted identification number for the use of financial transactions over a networked environment.

2. The use of an agent in the form of software that is temporarily or permanently loaded into the user's computer for the purpose of verifying the actual existence of a credit instrument that must physically reside as part of that computer's peripheral system.

3. A system of one or more embedded and encrypted account numbers residing on the same optical disc for the purpose of allowing multiple uses of the credit instruments. For example, a two number disc with an embedded and encrypted credit card number of charged purchases and an embedded and encrypted debit card number for the purpose of debited purchases.

4. The system of claim 3 further comprising of the use of an additional number or password that is kept by the user of the optical credit instrument for the sole purpose of identifying the current user as the owner of the credit instrument. The additional number or password, if not entered correctly, prevents the financial transaction from completing.

5. The system of claim 3 further comprising of the use of an agent or software component that is permanently or temporarily loaded onto the user's computer to verify the additional number (typically a Personal Identification Number or PIN) or password locally on the user's computer to prevent the need to transfer the additional number or password over a network.

6. The system of claim 3 further comprising of the procedure of loading the agent on the user's computer from either the optical disk or the network environment.

7. The system of claim 3 further comprising of the addition of a magnetic stripe on the optical disc credit instrument to allow the credit instrument to be used as a traditional credit card.

8. The optical disk of claim 1 further comprising of the use of multiple images of the encrypted credit card number to allow reading of the account number in severe environments where the instrument of credit/debit contains surface defects.

9. The optical disk of claim 1 further comprising of the use of multiple shipping addresses on the card for delivering purchased merchandise. Addresses can be verified prior to issuing the credit device. The user is provided a choice in addresses at the moment of transaction.

10. The optical disk of claim 1 further comprising of the embedding on the surface of the disc, a label that contains a hologram for the purpose of signifying that the disc is genuine and not a product of forgery.

11. The optical disk of claim 1 further comprising of the addition of a laminate on the surface of the disc for the purpose of including the user's name and optional account information.

12. The subject matter of claim 2 further comprising of the design of the downloaded software agent to accept traditional credit instruments through the process of manually entering the credit card number. Such software allows the transaction to proceed without security features if the merchant desires.
